(19) United States
(12) Patent Application Publication
(10) Pub. No.: US 2012/0268237 A1
(43) Pub. Date: Oct. 25, 2012

(54) SYSTEM AND METHOD FOR CONTROLLING DOOR

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 13/151,357

(22) Filed: Jun. 2, 2011

(30) Foreign Application Priority Data
Apr. 20, 2011 (TW) 100113733

(51) Int. Cl. G06F 7/04

(52) U.S. Cl. 340/5.7

(57) ABSTRACT

A method for controlling a door includes: capturing an image by a camera; setting a predetermined percentage; comparing the current image captured by the camera with a plurality of images for different people's faces based on the predetermined percentage to determine whether there is a person appearing in the current image; and controlling a driving unit of the door to open the door upon the condition that there is a person appearing in the current image.

### BACKGROUND

1. Technical Field

The present disclosure relates to a control system and a control method for a door.

2. Description of Related Art

Many automatic doors include a sensor (such as an infrared sensor). When the sensor senses a person within a predetermined area of the door, the door automatically opens. However, these sensors are unable to discern the difference between an animal and a person, which can be troublesome. In addition, users may want to customize the response of their automatic doors but are unable to do so.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic diagram of a door.

FIG. 2 is a block diagram of an exemplary embodiment of a system for controlling the door of FIG. 1.

FIG. 3 is a flowchart of an exemplary embodiment of a method for controlling the door of FIG. 1.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

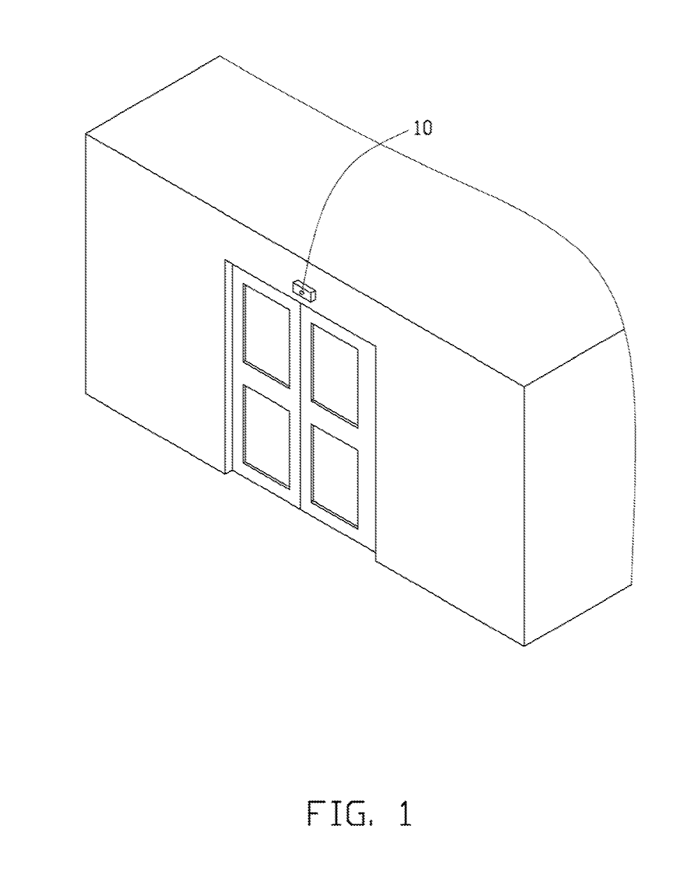

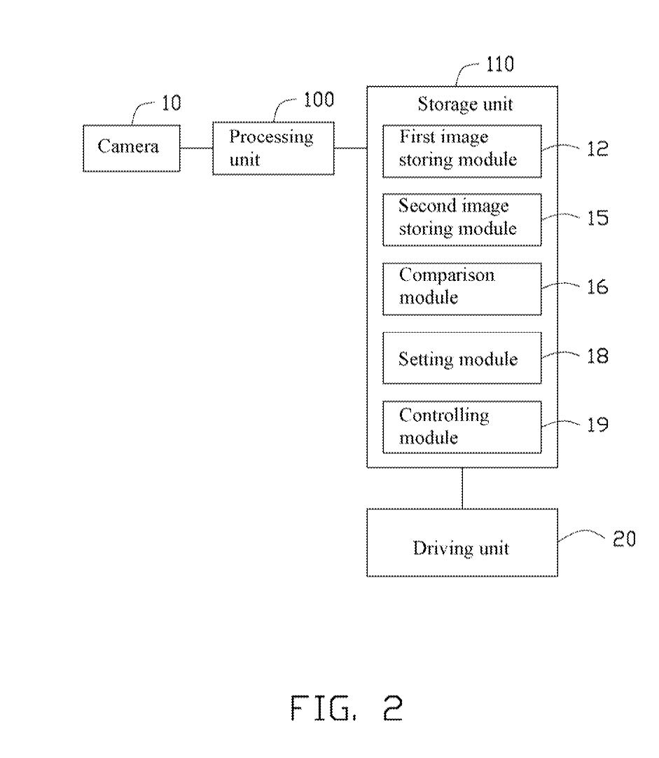

Referring to FIGS. 1 and 2, an exemplary embodiment of a system for controlling a door includes a camera 10, a processing unit 100, and a storage unit 110.

The storage unit 110 includes a first image storing module 15, a second image storing module 12, a comparison module 16, a setting module 18, and a controlling module 19, which may include computer code to be executed by the processing unit 100.

The camera 10 may be mounted above the door to capture images of the area in the vicinity of the door and in view of the camera 10. In other embodiments, the camera 10 can be mounted at other positions for capturing images of specific approaches to the door.

The first image storing module 15 stores a number of images for different peoples' faces. The camera 10 may be used to obtain the different images in advance. The second image storing module 12 is used to store current images captured by the camera 10.

The comparison module 16 compares the current images captured by the camera 10 with the images previously stored in the first image storing module 15 to determine whether there is a person appearing in the current image. If a portion of the image captured by the camera 10 is similar to one of the images stored in the first image storing module 15, a determination is made that the image captured by the camera 10 includes a face, namely, there is a person in the image. If the image captured by the camera 10 is different from all images stored in the first image storing module 15, a determination is made that there are no people in the image.

If the comparison module 16 determines that the image captured by the camera 10 includes a face, the comparison module 16 outputs a signal to the controlling module 19. The controlling module 19 outputs a control signal to a driving unit 20 accordingly. The driving unit 20 opens the door. In the embodiment, the driving unit 20 includes a rail and a motor. The driving unit 20 controls the motor to drive the door to move on the rail to open or close the door.

The setting module 18 is loaded or programmed with a predetermined percentage, such as 60%, as a basis for determining whether enough of a current image matches a previously stored image, when the comparison module 16 compares the current image captured by the camera 10 with the images stored in the first image storing module 15. In other words, when one of the images captured by the camera 10 is a 60 percentage match to one of the images previously stored in the first image storing module 15, the comparison module 16 determines that a person is present in the current image and the signal is sent and the door opens.

In this example, when the door is used for a shop, at 60% match, even if a customer wears a surgical mask and sunglasses, the comparison module 16 can still determine that the image captured by the camera 10 includes a face and the door will be opened.

However, for greater security, such as when the door is used for a bank, a bank manager may set a higher percentage (for example 90%). Requiring a 90% match means a clear view of a person's face must be captured in the current image for the door to be opened. Furthermore, if there is a crime, the images stored in the second image storing module 12 can help the police.

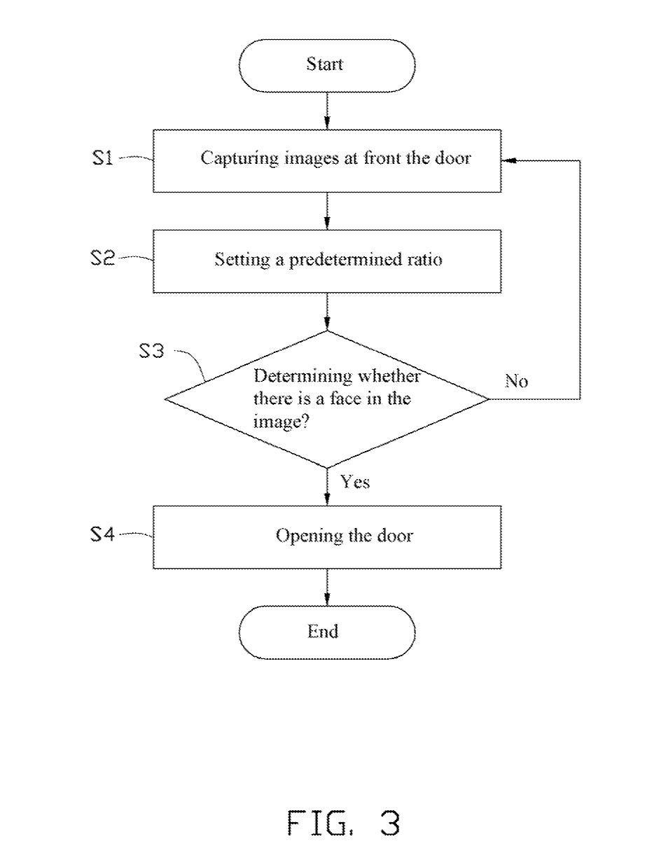

Referring to FIG. 3, an exemplary embodiment of a method for controlling the door includes the following steps.

In step S1, the camera 10 captures an image, and stores the current image in the second image storing module 12.

In step S2, the setting module 18 is loaded or programmed with a predetermined percentage, such as 60%.

In step S3, the comparison module 16 compares the current image with the images previously stored in the first image storing module 15 to determine whether there is a person appearing in the current image based on the predetermined percentage loaded in the setting module 18. If there is no person appearing in the current image, it returns to step S1. If there is a person appearing in the current image, it flows to step S4. In other words, when the image captured by the camera 10 is a 60% match to one of the image previously stored in the first image storing module 15, the comparison module 16 determines that a person is present in the current image.

In step S4, the controlling module 19 controls the driving unit 20 to open the door.

The foregoing description of the exemplary embodiments of the disclosure has been presented only for the purposes of illustration and description and is not intended to be exhaustive or to limit the disclosure to the precise forms disclosed. Many modifications and variations are possible in light of everything above. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A system for controlling a door, the system comprising:
a camera to capture an image;
a processing unit connected to the camera to receive the image;
a storage unit connected to the processing unit and storing a plurality of programs to be executed by the processing unit, wherein the storage unit comprises:
a first image storing module to store a plurality of images for different people's faces;
a setting module to be loaded or programmed with a predetermined percentage;
a comparison module to compare the current image captured by the camera with the images stored in the first image storing module to determine whether there is a person appearing in the current image based on the predetermined percentage; and
a controlling module to control a driving unit of the door to open the door upon the condition that the comparison module determines that there is a person appearing in the current image.

2. The system of claim 1, wherein the storage unit further comprises a second image storing module, the second image storing module stores the images captured by the camera.

3. A method for controlling a door, the method comprising:
capturing an image with a camera;
setting a predetermined percentage;
comparing the image captured by the camera with a plurality of images for different people's faces to determine whether there is a person appearing in the image based on the predetermined percentage; and
controlling a driving unit of the door to open the door upon the condition that there is a person appearing in the current image.

4. The method of claim 3, wherein upon the condition that there is no person appearing in the current image, it returns to the step of “capturing an image by a camera”.

5. The method of claim 4, wherein after the step “capturing an image by a camera” comprises:
storing the image captured by the camera.
